(19) United States
(12) Patent Application Publication
(10) Pub. No.: US 2008/0272963 A1
(43) Pub. Date: Nov. 6, 2008

(54) BROADBAND DIELECTRIC RESONATOR ANTENNA EMBEDDING MOAT AND DESIGN METHOD THEREOF

(75) Inventors: Tze-Hsuan Chang, Taipei City (TW); Jean-Fu Kiang, Taipei City (TW)

Correspondence Address: QUINTERO LAW OFFICE, PC, 2210 MAIN STREET, SUITE 200, SANTA MONICA, CA, 90405, US

(73) Assignee: NATIONAL TAIWAN UNIVERSITY, TAIPEI (TW)

(21) Appl. No.: 11/950,289

(22) Filed: Dec. 4, 2007

(30) Foreign Application Priority Data
May 2, 2007 (TW) TW96115557

(51) Int. Cl. H01Q 9/04; H01Q 1/38

(52) U.S. Cl. 343/700 MS

(57) ABSTRACT

An antenna is provided comprising a substrate, a feed conductor, a ground layer and a resonator body. The substrate comprises a first surface and a second surface. The feed conductor is formed on the first surface. The ground layer is formed on the second surface comprising an opening. The resonator body comprises a first resonator structure and a second resonator structure. The first resonator structure is disposed on the ground layer. The second resonator structure is disposed on the ground layer surrounding the first resonator structure, wherein a groove is formed between the first and the second resonator structures.

### BACKGROUND OF THE INVENTION

1. Field of the Invention

The invention relates to an antenna, and more particularly to a broadband dielectric resonator antenna.

2. Description of the Related Art

Conventional dielectric resonator antennas provide a narrow bandwidth. For increasing bandwidth, conventional dielectric resonator antenna combines different-shaped resonator structures. For example, conventional dielectric resonator antenna combines resonator structures with triangular or circular cross-sections for connecting bands thereof and increasing bandwidth. However, manufacturing processes of conventional dielectric resonator antenna are complicated, increasing costs and antenna height (size), and is hardly every utilized in portable electronic devices.

Another conventional dielectric resonator antenna combines a plurality of resonate modes to increase bandwidth. However, divergence field thereof changes with frequency by influence of high order resonate modes.

Additionally, another conventional dielectric resonator antenna comprises a plurality of openings formed in a resonator to intermit electric fields, decrease dielectric coefficient and increase bandwidth. However, manufacturing processes of conventional dielectric resonator antenna with openings are also complicated and costly.

### BRIEF SUMMARY OF THE INVENTION

A detailed description is given in the following embodiments with reference to the accompanying drawings.

The invention provides an antenna comprising a substrate, a feed conductor, a ground layer and a resonator body. The substrate comprises a first surface and a second surface. The feed conductor is formed on the first surface. The ground layer is formed on the second surface comprising an opening. The resonator body comprises a first resonator structure and a second resonator structure. The first resonator structure is disposed on the ground layer. The second resonator structure is disposed on the ground layer surrounding the first resonator structure, wherein a groove is formed between the first and the second resonator structures.

The antenna of the invention combines TE₁₁₁^{y}, TE₁₁₂^{y} and TE₁₁₃^{y} mode bands to provide bandwidth of 33%, and provides a bandwidth between 4.89 GHz to 6.86 GHz to satisfy requirement of WLAN 802.11 a with linear polarization and wider wave paddle. The antenna of the invention has smaller height and reduced cost, and can be incorporated with other planer circuits and easily produced in large scale by low temperature co-fired processes.

### BRIEF DESCRIPTION OF THE DRAWINGS

The invention can be more fully understood by reading the subsequent detailed description and examples with references made to the accompanying drawings, wherein:

FIG. 1 shows an antenna of the invention;

FIG. 2 is a top view of the antenna showing positions of a first resonator structure and a second resonator structure on a ground layer;

FIG. 3 shows transmission of the antenna of the invention; and

FIGS. 4a and 4b show dimensions of the antenna of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

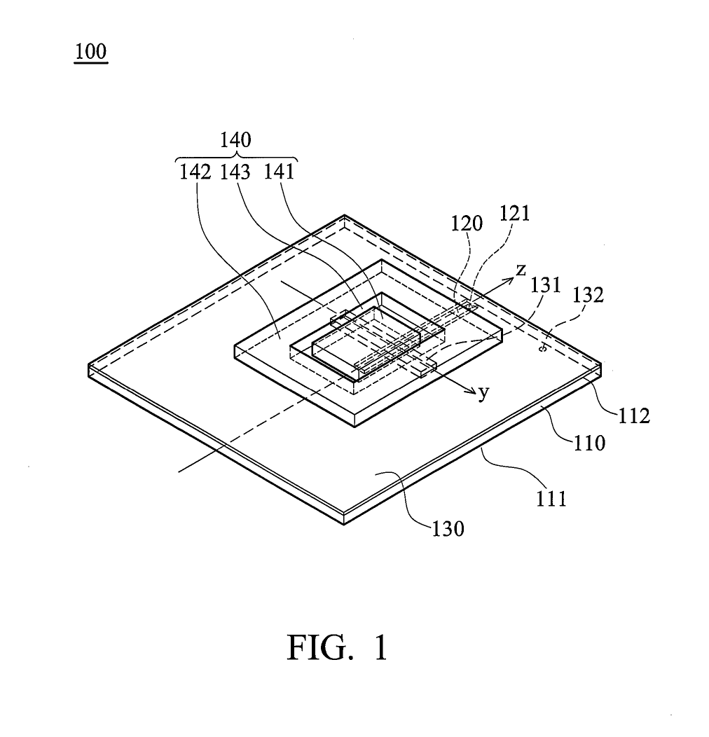

FIG. 1 shows an antenna 100 of the invention comprising a substrate 110, a feed conductor 120, a ground layer 130 and a resonator body 140. The substrate 110 comprises a first surface 111 and a second surface 112. The feed conductor 120 is formed on the first surface 111. The ground layer 130 is formed on the second surface 112. The ground layer 130 comprises an opening 131. The resonator body 140 comprises a first resonator structure 141 and a second resonator structure 142. The first resonator structure 141 is disposed on the ground layer 130. The second resonator structure 142 is disposed on the ground layer 130 surrounding the first resonator structure 141. A groove 143 is formed between the first resonator structure 141 and the second resonator structure 142. The feed conductor 120 comprises a feed point 121 located on an end of the feed conductor 120. The ground layer 130 comprises a ground point 132 formed on the ground layer 130.

The first resonator structure 141 is cube-shaped. The second resonator structure 142 surrounds a rectangular area. The opening 131 is longitudinal extending pass bottoms of the first resonator structure 141 and the second resonator structure 142. The feed conductor 120 is longitudinal, and also extends pass bottoms of the first resonator structure 141 and the second resonator structure 142. The feed conductor 120 extends along a first axis z, the opening 131 extends along a second axis y, and the first axis z is perpendicular to the second axis y. The feed conductor 120 correspondingly passes a center of the opening 131.

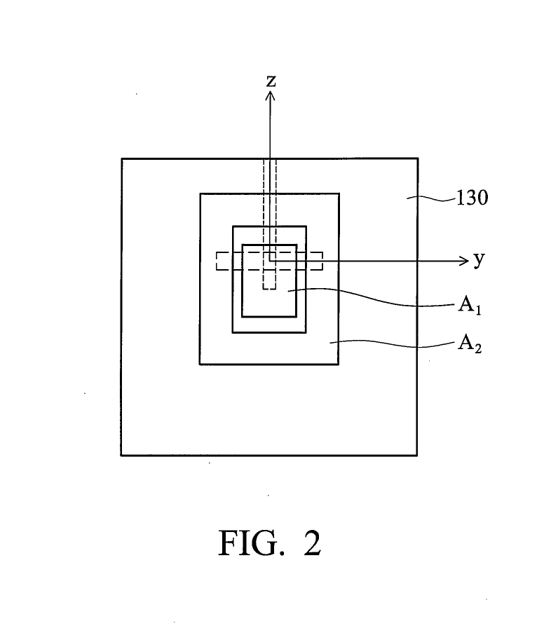

FIG. 2 is a top view of the antenna showing positions of the first resonator structure 141 and the second resonator structure 142 on the ground layer 130. The first resonator structure 141 defines a first contact area A₁ on the ground layer 130. The first axis z passes a center area of the first contact area A₁ parallel to a major axis of the first resonator structure 141. The second resonator structure 142 defines a second contact area A₂ on the ground layer 130. The first axis z passes a center area of the second contact area A₂.

The resonator body 140 is a dielectric resonator structure comprising low temperature co-fired ceramics or other high dielectric coefficient and low loss materials. The substrate 110 can comprise dielectric materials such as Teflon, glass fiber, Aluminum Oxide, ceramics, glass fiber plate (FR4), and microwave printed circuit board (Duroid).

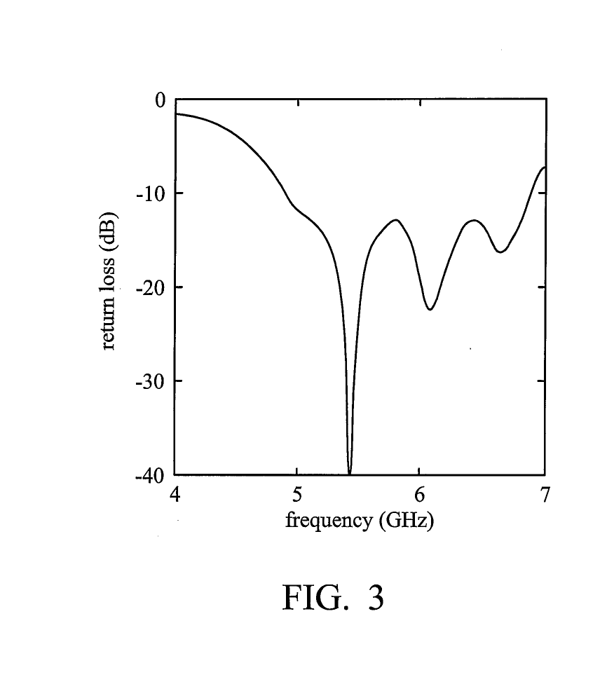

When wireless signal is transmitted, the signal travels from the feed conductor 120, passes the opening 131 and is coupled to the resonator body 140. Because dielectric coefficient of the resonator structures 141 and 142 is much greater than dielectric coefficient of air in the groove 143, electric field is enhanced when power lines pass the groove 143. Therefore, quality factor of the resonator structures is reduced. Additionally, the antenna of the invention combines TE₁₁₁^{y}, TE₁₁₂^{y} and TE₁₁₃^{y} mode bands to provide bandwidth of 33%. FIG. 3 shows transmission of the antenna 100 of the invention, which provides a bandwidth between 4.89 GHz to 6.86 GHz to satisfy requirement of WLAN 802.11a with linear polarization and wider wave paddle. In FIG. 3, bandwidth is defined as signals having return loss lower than −10 dB. The antenna of the invention has smaller height and reduced cost, and can be incorporated with other planer circuits and easily produced in large scale by low temperature co-fired processes.

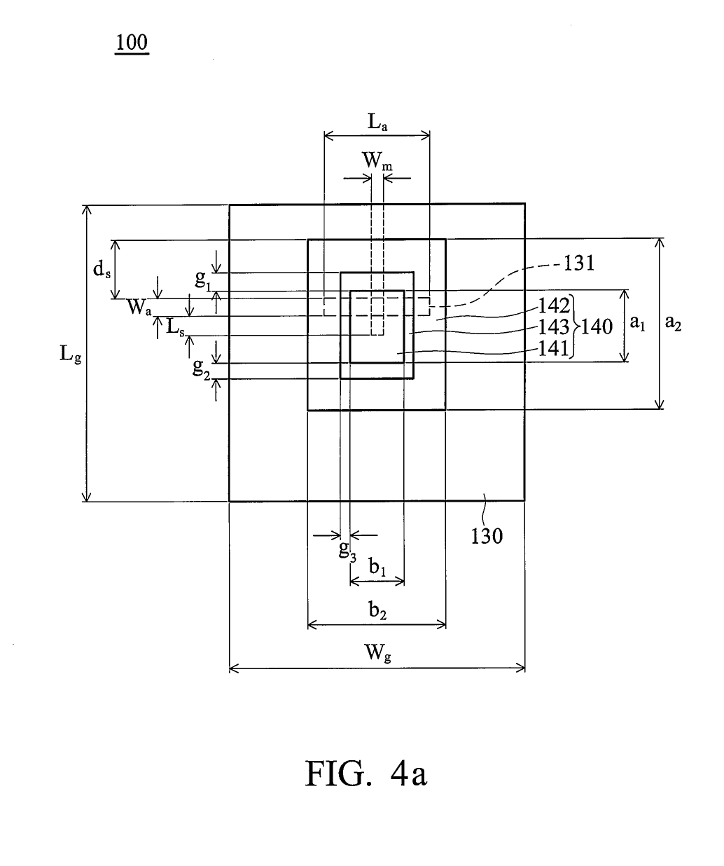

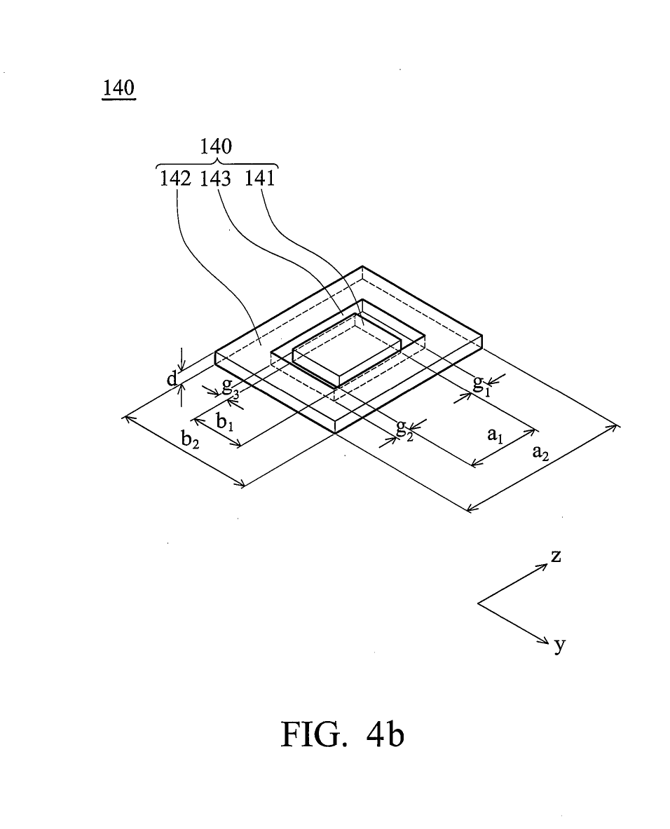

FIGS. 4a and 4b show dimensions of the antenna 100 of the invention. The resonator body 140 has length a₂, width b₂ and height d. The groove 143 has first width g₁, second width g₂ and third width g₃. The resonator structure 141 has length a₁, width b₁ and height d. The substrate 110 and the ground layer 130 have length L_{g} and width W_{g}. The feed conductor has width Wₘ, and extends over the opening 131 with length Lₛ. The opening 131 has length Lₐ and width Wₐ.

In the embodiment of the invention, the diameters of the resonator body 140 are a₁=16.2 mm, b₁=10 mm, a₂=30.5 mm, b₂=19 mm, d=4 mm, g₁=0.5 mm, g₂=4.5 mm and g₃=0.2 mm. The diameters of the opening are Wₐ=2 mm and Lₐ=13.5 mm. The diameters of the ground layer 130 are W_{g}=L_{g}=60 mm. Thickness t of the substrate 110 is t=0.6 mm. The dielectric coefficient of the substrate 110 is 4.4. The dielectric coefficient of the resonator structures 141 and 142 is 20. The opening 131 separates from an edge of the resonator body 140 in a distance dₛ=12.5 mm. The feed conductor extends over the opening 131 with length Lₛ=5 mm.

In the embodiment of the invention, frequency of the antenna can be modified by tuning diameters (length a₂, width b₂ and height d) of the resonator body 140. Frequency of the antenna can be modified, and bandwidth thereof can be increased by tuning diameters (first width g₁, second width g₂ and third width g₃) of the groove. Additionally, divergence field shape and divergence field bandwidth are also modified by tuning diameters of the groove. Input impedance can be modified by tuning diameters and positions of the opening and the feed conductor.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An antenna, comprising:
a substrate, comprising a first surface and a second surface;
a feed conductor, formed on the first surface;
a ground layer, formed on the second surface comprising an opening; and
a resonator body, comprising:
a first resonator structure, disposed on the ground layer; and
a second resonator structure, disposed on the ground layer surrounding the first resonator structure, wherein a groove is formed between the first and the second resonator structures.

2. The antenna as claimed in claim 1, wherein the first resonator structure is cube-shaped.

3. The antenna as claimed in claim 1, wherein the second resonator structure surrounds a rectangular area.

4. The antenna as claimed in claim 1, wherein the first and second resonator structures are dielectric resonator structures.

5. The antenna as claimed in claim 4, wherein the first and second resonator structures comprise low temperature co-fired ceramics.

6. The antenna as claimed in claim 1, wherein the opening extends pass a bottom of the first resonator structure and a bottom of the second resonator structure.

7. The antenna as claimed in claim 1, wherein the opening is longitudinal.

8. The antenna as claimed in claim 1, wherein the feed conductor is longitudinal, and extends pass a bottom of the first resonator structure and a bottom of the second resonator structure.

9. The antenna as claimed in claim 1, wherein the feed conductor extends along a first axis, the opening extends along a second axis, and the first axis is perpendicular to the second axis.

10. The antenna as claimed in claim 9, wherein the feed conductor correspondingly passes a center of the opening.

11. The antenna as claimed in claim 9, wherein the first resonator structure defines a first contact area on the ground layer, and the first axis passes a center of the first contact area.

12. The antenna as claimed in claim 9, wherein the second resonator structure defines a second contact area on the ground layer, and the first axis passes a center of the second contact area.

13. The antenna as claimed in claim 9, the first axes is parallel to a major axis of the first resonator structure.

14. The antenna as claimed in claim 1, further comprising a feed point and a ground point, wherein the feed point is located on an end of the feed conductor, and the ground point is located on the ground layer.

15. An antenna design method, comprising:
providing the antenna as claimed in claim 1;
tuning diameters of the resonator body to modify transmission frequency of the antenna; and
tuning diameters and position of the groove to modify transmission bandwidth and divergence field bandwidth.

16. The antenna design method as claimed in claim 15, wherein when the antenna transmits a wireless signal, the wireless signal travels from the feed conductor, passes the opening, and is fed into the resonator body.
